(19) United States
(12) Patent Application Publication
(10) Pub. No.: US 2017/0368919 A1
(43) Pub. Date: Dec. 28, 2017

(54) TRACK FOR COUPLING AN ENCLOSURE TO A VEHICLE AND METHOD OF MANUFACTURING THE SAME

(71) Applicant: Fabritec Industries, Inc., d/b/a DoorWorks Enclosures, St. Louis, MO (US)

(72) Inventor: Craig Guempel, St. Louis, MO (US)

(21) Appl. No.: 15/634,665

(22) Filed: Jun. 27, 2017

Related U.S. Application Data
(60) Provisional application No. 62/354,959, filed on Jun. 27, 2016.

(51) Int. Cl. B60J 5/04

(52) U.S. Cl. CPC B60J 5/0487; B60J 5/0469

(57) ABSTRACT

A track is provided for coupling an enclosure to a roof of a golf cart. The track includes a retention section and an access section. The retention section includes a first linear sidewall, a second linear sidewall spaced from the first linear sidewall to define an enclosure channel therebetween, a first lip portion extending from a first end portion of the first linear sidewall generally toward the second linear sidewall, and a second lip portion extending from a second end portion of the second linear sidewall generally toward the first linear sidewall. The second lip portion is spaced from the first lip portion to define a slot therebetween. The slot is sized to retain an enclosure cord extending through the enclosure channel in the enclosure channel. The access section includes an open sidewall coupled to the first linear sidewall or the second linear sidewall. The access section is configured to provide access to a longitudinal end portion of the retention section for removably extending the enclosure cord through the enclosure channel.

### CROSS-REFERENCE TO RELATED APPLICATION

This application claims the benefit of U.S. Provisional Application No. 62/354,959, flied on Jun. 27, 2016, which is hereby incorporated by reference in its entirety.

### BACKGROUND

Vehicles, such as golf carts, may be used to transport people and/or objects from one location to another. Some conventional golf carts include a roof mounted to a cart frame to protect its occupants from the environment. Conventional golf carts are side-door free to facilitate quick and convenient ingress into the cabin area and egress out of the cabin area. During inclement weather, however, the cabin area of such golf carts may be exposed to weather elements, such as cold temperatures, rain, and/or high winds.

At least some conventional golf carts include awnings, curtains, and/or enclosure panels connected to the frame and/or roof to provide protective covering for the cabin. Known tracks that couple such awnings, curtains, and/or enclosure panels to golf carts, however, are fastened to the frame and/or roof in a manner that may compromise the integrity of the frame and/or roof. Set screw fasteners, for example, extend through the frame and/or roof and may create weak points that lead to failure or corrosion. Furthermore, such set screw fasteners may present safety issues, as workers or users my cut themselves on the set screw fasteners.

### SUMMARY

Examples of the disclosure enable an enclosure to be removably coupled to a roof of a golf cart. A track includes a retention section and an access section. The retention section includes a first linear sidewall, a second linear sidewall spaced from the first linear sidewall to define an enclosure channel therebetween, a first lip portion extending from a first end portion of the first linear sidewall generally toward the second linear sidewall, and a second lip portion extending from a second end portion of the second linear sidewall generally toward the first linear sidewall. The second lip portion is spaced from the first lip portion to define a slot therebetween. The slot is sized to retain an enclosure cord extending through the enclosure channel in the enclosure channel. The access section includes an open sidewall coupled to the first linear sidewall or the second linear sidewall. The access section is configured to provide access to a longitudinal end portion of the retention section for removably extending the enclosure cord through the enclosure channel.

In another aspect, a system is provided for fabricating a track. The system includes a die component, a removal component, and a bend component. The die component is configured to form a raw track. The die component includes a plurality of die walls arranged generally in a rectangular configuration and a first member extending substantially perpendicularly from a first die wall of the plurality of die walls. The first member includes a body portion having a first width and a stem portion having a second width less than the first width such that the die component is configured to form a first linear sidewall between the body portion and the second die wall, a second linear sidewall between the body portion and the third die wall, a first lip portion between the stem portion and the second die wall, and a second lip portion between the stem portion and the third die wall. The removal component is configured to locate an access section of the raw track and, from the access section, remove one of the first linear sidewall or the second linear sidewall. The bend component is configured to bend the access section.

In yet another aspect, a method is provided for fabricating a track configured to couple an enclosure to a roof of a golf cart. The method includes forming a first raw track including a first linear sidewall, a second linear sidewall spaced from the first linear sidewall to define an enclosure channel therebetween, a first lip portion extending from a first end portion of the first linear sidewall generally toward the second linear sidewall, and a second lip portion extending from a second end portion of the second linear sidewall generally toward the first linear sidewall. The second lip portion is spaced from the first lip portion to define a slot therebetween. The slot is sized to retain an enclosure cord extending through the enclosure channel in the enclosure channel. The method further includes locating one or more access sections of the first raw track, removing, from the one or more access sections, the first linear sidewall or the second linear sidewall, and bending the one or more access sections.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Features, aspects, and advantages of the present disclosure will become better understood when the following Detailed Description is read with reference to the accompanying drawings in which like characters represent like parts throughout, wherein:

FIG. 1 is a side plan view an example golf cart including a golf cart roof.

FIG. 2 is a bottom view of an example track coupled to a golf cart roof, such as the golf cart roof shown in FIG. 1.

FIG. 3 is a partial cutaway view of an example retention section of a track, such as the track shown in FIG. 2, coupling an enclosure to a golf cart roof, such as the golf cart roof shown in FIG. 1.

FIG. 4 is a perspective view of an example retention section, such as the retention section shown in FIG. 3.

FIGS. 5 and 6 are perspective views of example access sections of a track, such as the track shown in FIG. 2.

FIG. 7 is an exploded view of an example track, such as the track shown in FIG. 2, including one or more retention sections and one or more access sections, such as the retention section shown in FIG. 3 or 4 and the access section shown in FIG. 5 or 6.

FIG. 8 is a block diagram of an example system for fabricating a track, such as the track shown in FIG. 2.

FIG. 9 is a flowchart of an example method of fabricating a track, such as the track shown in FIG. 2.

### DETAILED DESCRIPTION

The present disclosure relates to coupling mechanisms and, more particularly, to a track system that couples an enclosure to a roof of a vehicle. The examples described herein include a retention section configured to retain an enclosure cord and an access section configured to provide access to a longitudinal end portion of the retention section for inserting and/or removing the enclosure cord. The examples described herein allow a user to install a track and/or couple an enclosure to a vehicle in a convenient, efficient, safe, and/or economical manner. The examples described herein are lightweight and durable. The examples described herein include a variety of configurations, and the description and/or figures that utilize a golf cart are exemplary only. The examples described herein may be used with any open-sided vehicle, such as personal transport vehicles, tractors, all-terrain vehicles, lawn equipment, construction equipment, and/or farm equipment.

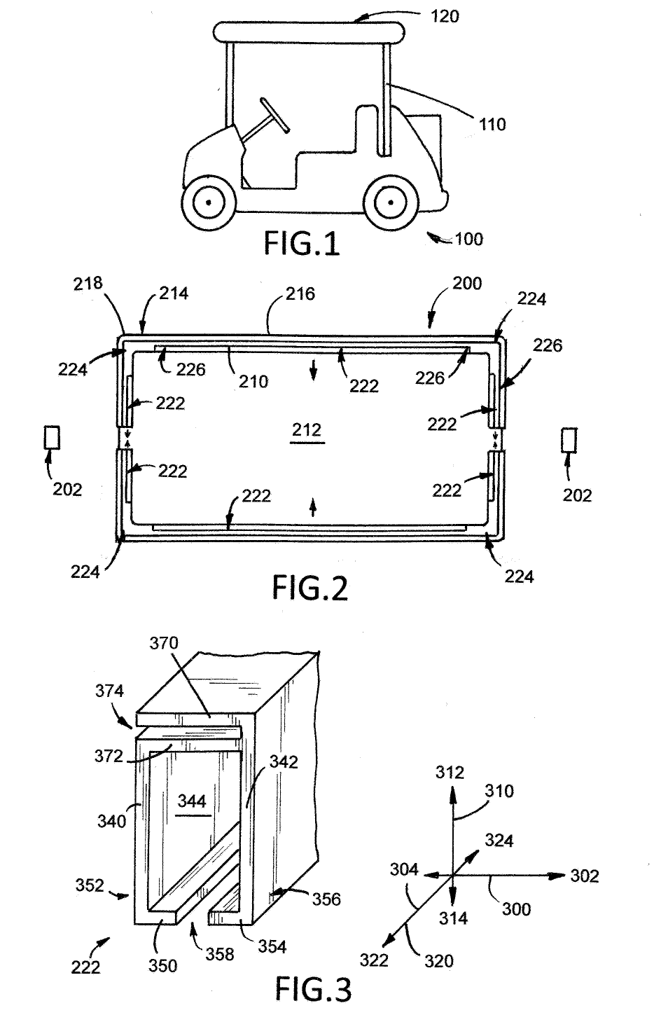

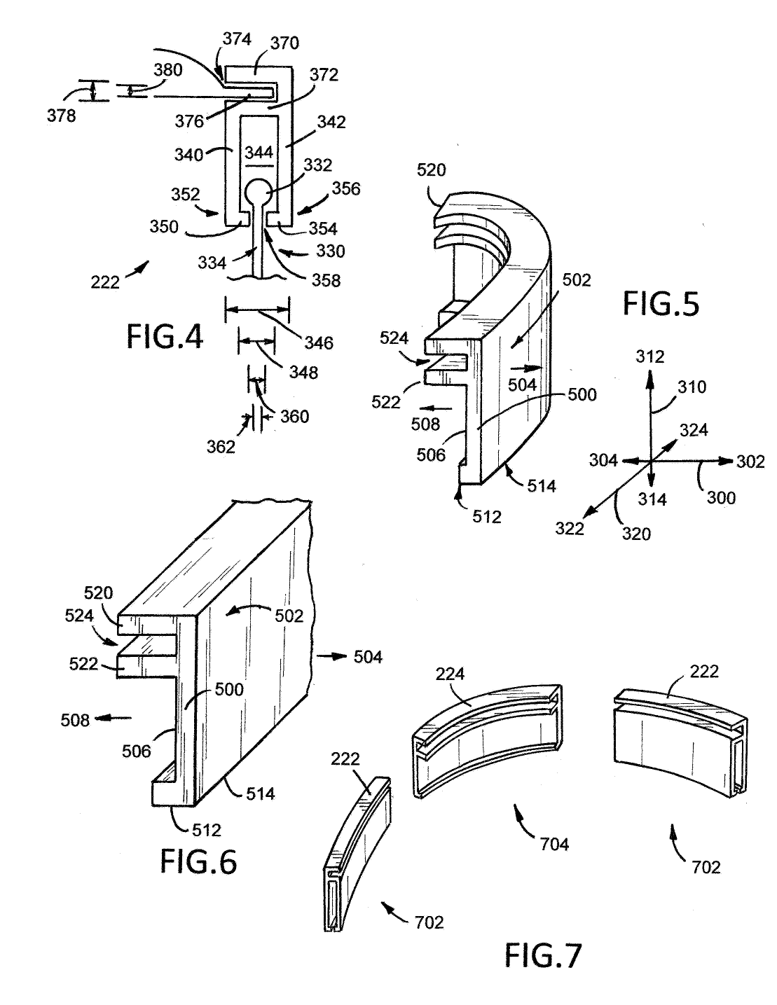

FIG. 1 shows an example golf cart 100. The golf cart 100 includes a frame 110 and a roof 120 coupled to the frame 110. The frame 110 and/or roof 120 define a cabin 130 in which one or more occupants may be seated and/or equipment may be stored. The cabin 130 is generally open to the ambient environment. An enclosure (shown in FIG. 4) may be coupled to the golf cart 100 to at least partially enclose the cabin 130. In this manner, the enclosure may be used to provide at least some protection for the occupants and/or equipment from the ambient environment. While FIG. 1 shows a smaller (e.g., two person) golf cart, the systems and methods described herein may be used with any open-sided vehicle, including larger (e.g., four person, six person, eight person) golf carts.

FIG. 2 shows one or more example tracks 200 that may be used to couple an enclosure to a roof 120 of a golf cart 100 (shown in FIG. 1). The track 200 may provide a lightweight yet durable framework for support and rigidity for the roof 120. The track 200 may be fabricated from a variety of materials, such as an aluminum material. In some examples, the track 200 is fabricated from an extrudable material at a variety of lengths, widths, thicknesses, and/or shapes such that the track 200 may be mitered, punched, repaired, or otherwise processed to function as described herein. In some examples, a coupling mechanism 202 securely couples one or more tracks 200 to the roof 120 such that the tracks 200 are stationary or do not move relative to the golf cart 100. Additionally or alternatively, the coupling mechanism 202 may securely couple a plurality of tracks 200 to the roof 120 such that the tracks 200 are stationary or do not move relative to each other.

In some examples, a first track 210 of the plurality of tracks 200 is coupled to the roof 120 such that the first track 210 at least partially circumscribes a body portion 212 of the roof 120. For example, the first track 210 may extend generally about a periphery of the roof 120 along one or more edge portions 214 of the roof 120, including one or more side edge portions 216 and/or one or more corner edge portions 218. In some examples, the first track 210 includes one or more retention sections 222 extending generally along the side edge portions 216 and/or one or more access sections 224 extending generally along the corner edge portions 218. In this manner, a first segment of an enclosure (shown in FIG. 4) may extend along a retention section 222, and a second segment of the enclosure may extend along an access section 224. The retention sections 222 are configured to retain at least a portion of the enclosure for coupling the enclosure to the golf cart 100, and the access sections 214 are configured to provide access to a longitudinal end portion 226 of an adjacent retention section 222. Access may be provided to the longitudinal end portion 226 of a retention section 222, for example, to selectively and/or removably couple the enclosure to the roof 120.

FIG. 3 shows an example retention section 222 oriented such that an X-axis 300 defines a positive lateral (e.g., outward) direction 302 and a negative lateral (e.g., inward) direction 304, a Y-axis 310 defines a positive vertical (e.g., upward) direction 312 and a negative vertical (e.g., downward) direction 314, and a Z-axis 320 defines a positive longitudinal direction 322 and a negative longitudinal direction 324. FIG. 4 shows the retention section 222 coupling an enclosure 330 to a roof 120 of a golf cart 100 (shown in FIG. 1). As shown in FIG. 4, the enclosure 330 includes an enclosure cord 332 and an enclosure panel 334 extending from the enclosure cord 332. The enclosure panel 334 may extend generally downward (e.g., in the negative vertical direction 314) and/or hang from an enclosure cord 332 coupled to the roof 120, for example, to at least partially enclose the cabin 130 (shown in FIG. 1).

The retention section 222 includes a first linear sidewall 340 and a second linear sidewall 342 laterally spaced from the first linear sidewall 340 to define an enclosure channel 344 therebetween. For example, an inner sidewall (e.g., the first linear sidewall 340) may define one side area of the enclosure channel 344, and/or an outer sidewall (e.g., the second linear sidewall 342) may define another side area of the enclosure channel 344. The first linear sidewall 340 extends vertically and/or longitudinally generally parallel to the second linear sidewall 342. As shown in FIG. 4, the enclosure channel 344 is sized to allow the enclosure cord 332 to extend therethrough. For example, the second linear sidewall 342 may be spaced from the first linear sidewall 340 a distance 346 (e.g., a first distance) greater than a width 348 of the enclosure cord 332 (e.g., a first width). In this manner, the enclosure cord 332 may be selectively and/or removably extended longitudinally through the enclosure channel 344, between the first linear sidewall 340 and second linear sidewall 342, from a longitudinal end portion 226 (shown in FIG. 2) of the retention section 222.

Additionally, the retention section 222 includes a first lip portion 350 extending laterally from a lower end portion 352 of the first linear sidewall 340 (e.g., a first end portion) and a second lip portion 354 extending laterally from a lower end portion 356 of the second linear sidewall 342 (e.g., a second end portion). The first lip portion 350 may extend generally toward the lower end portion 356 of the second linear sidewall 342, and/or the second lip portion 354 may extend generally toward the lower end portion 352 of the first linear sidewall 340, to partially define the enclosure channel 344. For example, the first lip portion 350 and/or second lip portion 354 may define one or more shallow areas of the enclosure channel 344. The first lip portion 350 is at the same or a substantially similar elevation or height as that of the second lip portion 354.

The second lip portion 354 is spaced from the first lip portion 350 to define a slot 358 therebetween, For example, an inner lip portion (e.g., the first lip portion 350) may define one side area of the slot 358, and/or an outer lip portion (e.g., the second lip portion 354) may define another side area of the slot 358. The first lip portion 350 and/or second lip portion 354 extend longitudinally generally parallel to each other and/or to the first liner sidewall 340 and/or second linear sidewall 342. As shown in FIG. 4, the slot 358 is sized to retain the enclosure cord 332 within the enclosure channel 344. For example, the second lip portion 354 may be spaced from the first lip portion 350 a distance 360 (e.g., a second distance) less than the width 348 of the enclosure cord 332 and greater than a width 362 of the enclosure panel 334 (e.g., a second width). In this manner, the enclosure cord 332 may be restricted from passing vertically through the slot 358 while the enclosure panel 334 may be allowed to pass vertically through the slot 358.

In some examples, the retention section 222 includes a first projection 370 and a second projection 372 vertically spaced from the first projection 370 to define a roof channel 374 therebetween. For example, an upper projection (e.g., the first projection 370) may define one side area of the roof channel 374, and/or a lower projection (e.g., the second projection 372) may define another side area of the roof channel 374. The first projection 370 extends laterally and/or longitudinally generally parallel to the second projection 372. As shown in FIG. 4, the roof channel 374 is sized to allow a lip or an edge portion 376 of the roof 120 to extend therethrough. For example, the second projection 372 may be spaced from the first projection 370 a distance 378 similar to and/or greater than a height 380 of the edge portion 376. In this manner, the edge portion 346 may be selectively and/or removably received in the roof channel 374, between the first projection 370 and second projection 370, for removably coupling the roof 120 to the retention section 222. Is some examples, the first projection 370 and/or second projection 372 enable the track 200 to be coupled to the roof 120 using an interference fit, press fit, or friction fit. Additionally or alternatively, the first projection 370 and/or second projection 372 provide one or more surfaces oriented to receive one or more coupling mechanisms (e.g., fasteners) for coupling the track 200 to the roof 120.

In some examples, the first projection 370 and/or second projection 372 extends laterally from the first linear sidewall 340 and/or second linear sidewall 344 substantially perpendicular to the first linear sidewall 340 and/or second linear sidewall 344. For example, an outer sidewall (e.g., the second linear sidewall 342) may define a deep area of the roof channel 374. Additionally, the first projection 370 or the second projection 372 may extend between the first linear sidewall 340 and the second linear sidewall 344 to partially define the enclosure channel 344. For example, a lower projection (e.g., second projection 372) may define a deep area of the enclosure channel 344.

FIGS. 5 and 6 show example access sections 224 oriented such that the X-axis 300 defines the outward direction 302 and the inward direction 304, the Y-axis 310 defines the upward direction 312 and downward direction 314, and the Z-axis 320 defines the positive longitudinal direction 322 and the negative longitudinal direction 324. The access section 224 includes an open sidewall 500 coupleable to the first linear sidewall 340 or second linear sidewall 342. In some examples, a first longitudinal segment of the access section 224 is generally aligned with the retention section 222, and/or a second longitudinal segment of the access section 224 is substantially perpendicular to the retention section 222. FIG. 5, for example, shows the access section 224 in a generally arcuate configuration. FIG. 6 shows the access section 224 in a generally linear configuration. In some examples, the access section 224 shown in FIG. 6 is bent to form the access section 224 shown in FIG. 5.

The access section 224 is configured to provide access to the longitudinal end portion 226 of an adjacent retention section 222 for selectively and/or removably extending the enclosure cord 332 longitudinally through the enclosure channel 344. In some examples, the access provided by the access section 224 is generally unobstructed by another portion of the track 200. For example, a first surface 502 of the open sidewall 500 oriented to face a first direction 504 (e.g., an outer surface facing the outward direction 302) may be unobstructed by another portion of the track 200, and/or a second surface 506 of the open sidewall 500 oriented to face a second direction 508 opposite the first direction 504 (e.g., an inner surface facing the inward direction 304) may be unobstructed by another portion of the track 200. In this manner, when the open sidewall 500 is coupled to an outer sidewall (e.g., the second linear sidewall 342), the enclosure cord 332 may be inserted into the enclosure channel 344 from under the roof 120 (e.g., from inside the golf cart 100). Alternatively, when the open sidewall 500 is coupled to an inner sidewall (e.g., the first linear sidewall 340), the enclosure cord 332 may be inserted into the enclosure channel 344 from outside the golf cart 100.

In some examples, the access section 224 includes a corner lip portion 512 extending laterally from an end portion 514 (e.g., a lower end portion) of the open sidewall 500. The corner lip portion 512 may provide structure support to the access section 224 and/or the enclosure cord 332. The corner lip portion 512 may extend in any direction that enables the track 200 to function as described herein. For example, when the open sidewall 500 is coupled to the second linear sidewall 342, the corner lip portion 512 may be longitudinally aligned generally with the second lip portion 354 of the retention section 222 and/or extend laterally generally in the inward direction 304. For another example, when the open sidewall 500 is coupled to the first linear sidewall 340, the corner lip portion 512 may be longitudinally aligned generally with the first lip portion 350 of the retention section 222 and/or extend generally in the outward direction 302.

In some examples, the access section 224 includes a first projection 520 and a second projection 522 vertically spaced from the first projection 520 to define a roof channel 524 therebetween. The first projection 520 may have the same or substantially similar configuration as that of the first projection 370 of the retention section 222, and/or the second projection 522 may have the same or substantially similar configuration as that of the second projection 372 of the retention section 222. For example, the first projection 520 may be longitudinally aligned generally with the first projection 370 of the retention section 222, and/or the second projection 522 may be longitudinally aligned generally with the second projection 372 of the retention section 222. When the first projection 370 of the retention section 222 and the first projection 520 of the access section 224 are integrally formed, and the second projection 372 of the retention section 222 and the second projection 522 of the access section 224 are integrally formed, the track 200 may define one continuous roof channel that enables the track 200 to be coupleable to the roof 120.

FIG. 7 shows a portion of the track 200 including one or more retention sections 222 and/or one or more access sections 224. In some examples, the retention sections 222 are generally along the sides 702 of the track 200, and the access sections 224 are generally at the corners 704 of the track 200. In this manner, at least a longitudinal segment of an open sidewall 500 of the access section 224 may have a generally arcuate configuration. Alternatively, any section of the track 200 (e.g., retention section 222, access section 224) may be at any segment of the track 200 that enables the track 200 to function as described herein.

In some examples, a single retention section 222 having a length of the track 200 is formed, and the retention section 222 is processed to create one or more access sections 224 such that access may be provided to one or more longitudinal end portions 226 of the remaining retention sections 222 from the access sections 224. For example, one or more sidewalls (e.g., first linear sidewall 340, second linear sidewall 342) and/or lip portions (e.g., first lip portion 350, second lip portion 354) may be removed from a segment of the track 200 to convert a retention section 222 into an access section 224. Alternatively, one section (e.g., retention section 222, access section 224) may be separately formed and coupled to one or more other sections to fabricate one or more segments of the track 200.

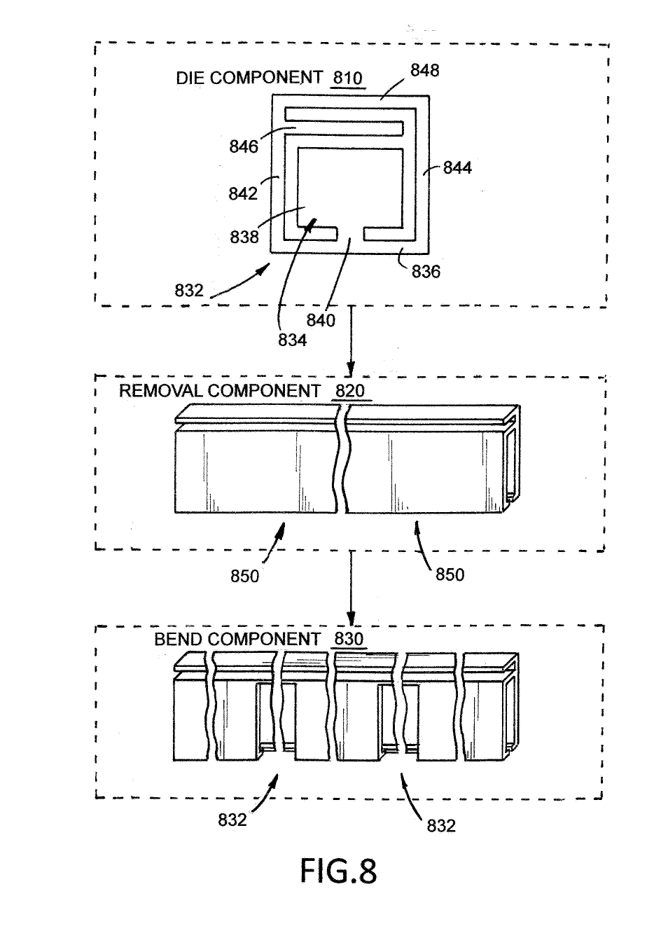

FIG. 8 shows a system 800 for manufacturing or fabricating a track 200. The system 800 includes a die component 810, a removal component 820, and a bend component 830. The die component 810 is configured to form a raw track. Track materials may be extruded, for example, through the die component 810. The die component 810 may include, for example, a plurality of die walls 832 arranged generally in a rectangular configuration, and a first member 834 extending substantially perpendicularly from a lower die wall 836 (e.g., a first die wall). The first member 834 includes a body portion 838 corresponding to the enclosure channel 344 and a stem portion 840 corresponding to the slot 358. For example, the body portion 838 may have a first width (e.g., distance 346) such that the die component 810 is configured to form a first linear sidewall 340 between the body portion 838 and an inner die wall 842 (e.g., a second die wall) and a second linear sidewall 342 between the body portion 838 and an outer die wall 844 (e.g., a third die wall). Additionally, the stem portion 840 may have a second width less than the first width (e.g., distance 360) such that the die component 810 is configured to form a first lip portion 350 between the stem portion 840 and the inner die wall 842, and a second lip portion 354 between the stem portion 840 and the outer die wall 844.

In some examples, the die component 810 includes a second member 846 extending substantially perpendicularly from the inner die wall 842 or the outer die wall 844. The second member 846 is spaced from an upper die wall 848 (e.g., a fourth die wall) and the first member 834 such that the die component 810 is configured to form a first projection 370 between the second member 846 and the upper die wall 848 and a second projection 372 between the second member 846 and the first member 834.

The removal component 820 is configured to locate one or more segments 850 of the raw track at which one or more access sections 224 are to be formed. From the located segments 850, the first linear sidewall 340 or the second linear sidewall 342 are removed to create one or more access sections 224 such that access may be provided to one or more longitudinal end portions 226 of the remaining retention sections 222 from the access sections 224.

The bend component 830 is configured to locate one or more segments 852 of the track at which one or more bends are to be formed. The bend component 830 may determine, for example, that the track is to be bent at the segments 850 associated with the access sections 224. The bend component 830 may be configured to bend one or more segments 852 such that at least a longitudinal segment of an access section 224 has a generally arcuate configuration. The bend component 830 may be configured, for example, to bend the segments 852 such that a first longitudinal segment of the access section 224 is generally aligned with a retention section 222 and a second longitudinal segment of the access section 224 is substantially perpendicular to the retention section 222. In some examples, the bend component 830 includes one or more dies that physically bend the track 200 at the segments 852.

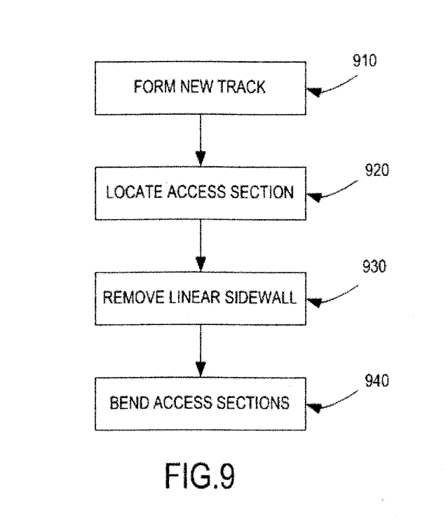

FIG. 9 is a flowchart of an example method 900 of fabricating a track 200. A raw track is formed at operation 910. The raw track includes a first sidewall (e.g., first linear sidewall 340) and a second sidewall spaced from the first sidewall (e.g., second linear sidewall 342) to define a channel (e.g., enclosure channel 344) therebetween. The first track may also include a first lip (e.g., first lip portion 350) extending from a first end portion of the first sidewall (e.g., lower end portion 352) generally toward the second sidewall, and a second lip (e.g., second lip portion 354) extending from a second end portion of the second sidewall (e.g., lower end portion 356) generally toward the first sidewall. The second lip may be spaced, for example, from the first lip to define a slot (e.g., slot 358) sized to retain an enclosure cord (e.g., enclosure cord 332) in the channel.

In some examples, the raw track is formed to include a first projection (e.g., first projection 370) and a second projection (e.g., second projection 372) spaced from the first projection such that the first projection and the second projection define a channel (e.g., roof channel 374) sized to receive an edge portion 376 of the roof 120 of the golf cart 100 (shown in FIG. 1). The first projection and/or the second projection may be substantially perpendicular to the first sidewall and/or the second sidewall. Additionally or alternatively, the first projection or second projection may extend between the first sidewall and the second sidewall to partially define the channel defined between the first sidewall and the second sidewall.

One or more access sections of the raw track (e.g., access section 224) are located at operation 920. From the located access sections, the first sidewall or the second sidewall are removed at operation 930 to provide a partially-processed track. Moreover, one or more of the located access sections are bent at operation 940 to provide a processed or custom track. A first access section, for example, may be bent such that a first longitudinal segment of the first access section is substantially perpendicular to a second longitudinal segment of the first access section. Additionally or alternatively, the first access section may be bent such that at least a longitudinal segment of the first access section has a generally arcuate configuration. After one or more processing operations (e.g., operation 910, operation 920, operation 930, and/or operation 940), the custom track may be coupled to the roof 120 of the golf cart 100.

Upon coupling the custom track to the roof 120, an installer may couple an enclosure 330 to the roof 120 using the custom track. In this manner, the custom track enables the installer to couple the enclosure 330 to the roof 120 without any additional tools or hardware. A longitudinal end portion 226 of a retention section 222, for example, may be identified adjacent to an access section 224, and an enclosure cord 332 of the enclosure 330 may be inserted into an enclosure channel 344 at the longitudinal end portion 226. The enclosure cord 332 may be pushed from the longitudinal end portion 226 to move or slide the enclosure cord 332 longitudinally along the enclosure channel 344. In some examples, the first lip portion 350 and/or second lip portion 354 provides support to the enclosure cord 332 from below while the enclosure panel 334 hangs between the first lip portion 350 and/or second lip portion 354. Additionally or alternatively, a portion of the enclosure panel 334 extending through the slot 358 or hanging below the slot 358 may be pulled longitudinally along the slot 358 to move or slide move or slide the enclosure cord 332 longitudinally along the enclosure channel 344. Upon extending the enclosure cord 332 through a length of one retention section 222, the enclosure cord 332 emerges from the enclosure channel 344 at the opposite longitudinal end portion of the retention section 222 and may be further inserted into another enclosure channel 344. In this manner, the enclosure 330 may be coupled to the roof 120 at one or more retention sections 222 in an efficient, quick, and convenient manner. Additionally, the enclosures 300 may be easily removed from the track 200 and/or the track 200 may be disassembled from the roof 120 in an efficient, quick, and convenient manner.

Example tracks are described herein and illustrated in the accompanying drawings. This written description uses examples to disclose aspects of the disclosure and also to enable a person skilled in the art to practice the aspects, including making or using the above-described devices, assemblies, and/or systems and executing or performing the above-described operations. When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. Moreover, the terms “comprising,” “including,” and “having” are intended to be inclusive and mean that there may be additional elements other than the listed elements. Furthermore, the phrase “one or more of the following: A, B, and C” means “at least one of A and/or at least one of B and/or at least one of C.”

While aspects of the disclosure have been described in terms of various examples with their associated operations, a person skilled in the art would appreciate that a combination of operations from any number of different examples is also within the scope of the disclosure. For example, components of the systems described herein and/or operations of the methods described herein may be utilized independently and separately from other components and/or operations. Moreover, the order of execution or performance of the operations described herein and illustrated in the accompanying drawings is not essential, unless otherwise specified. That is, the operations may be performed in any order, unless otherwise specified, and the methods described herein may include additional or fewer operations than those disclosed herein. For example, it is contemplated that executing or performing a particular operation before, contemporaneously with, or after another operation is within the scope of the disclosure. Although specific features may be shown in some of the accompanying drawings and not in others, this is for convenience only. In accordance with the examples described herein, any feature of a drawing may be referenced and/or claimed in combination with any feature of any other drawing.

Having described aspects of the disclosure in detail, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense. The scope of the disclosure may include other examples that occur to those skilled in the art. Such other examples are intended to be within the scope of the appended claims if they have structural elements that do not differ from the literal language of the claims, and/or if they include equivalent structural elements with insubstantial differences from the literal language of the claims.

What is claimed is:

1. A track for coupling an enclosure to a roof of a golf cart, the track comprising:
a retention section including a first linear sidewall, a second linear sidewall spaced from the first linear sidewall to define an enclosure channel therebetween, a first lip portion extending from a first end portion of the first linear sidewall generally toward the second linear sidewall, and a second lip portion extending from a second end portion of the second linear sidewall generally toward the first linear sidewall, the second lip portion spaced from the first lip portion to define a slot therebetween, the slot sized to retain an enclosure cord extending through the enclosure channel in the enclosure channel; and
an access section including an open sidewall coupled to one of the first linear sidewall or the second linear sidewall, the access section configured to provide access to a longitudinal end portion of the retention section for removably extending the enclosure cord through the enclosure channel.

2. The track of claim 1, wherein the retention section includes a first projection and a second projection spaced from the first projection to define a roof channel therebetween, the roof channel sized to receive an edge portion of the roof of the golf cart for removably coupling the retention section to the roof of the golf cart.

3. The track of claim 1, wherein the retention section includes a first projection and a second projection spaced from the first projection to define a roof channel therebetween, one of the first projection or the second projection extending between the first linear sidewall and the second linear sidewall to partially define the enclosure channel.

4. The track of claim 1, wherein the retention section includes a first projection and a second projection spaced from the first projection to define a roof channel therebetween, the first projection and the second projection substantially perpendicular to the first linear sidewall and the second linear sidewall.

5. The track of claim 1, wherein the access section includes a first projection and a second projection spaced from the first projection to define a roof channel therebetween, the roof channel sized to receive an edge portion of the roof of the golf cart for removably coupling the access section to the roof of the golf cart.

6. The track of claim 1, wherein a first surface of the open sidewall is oriented to face a first direction, and a second surface of the open sidewall is oriented to face a second direction opposite the first direction, the first direction and the second direction unobstructed by another portion of the track.

7. The track of claim 1, wherein a first longitudinal segment of the access section is generally aligned with the retention section, and a second longitudinal segment of the access section is substantially perpendicular to the retention section.

8. The track of claim 1, wherein at least a longitudinal segment of the open sidewall has a generally arcuate configuration.

9. The track of claim 1, wherein the access section includes a corner lip portion extending from an end portion of the open sidewall.

10. A system for fabricating a track, the system comprising:
a die component configured to form a raw track, the die component including a plurality of die walls arranged generally in a rectangular configuration and a first member extending substantially perpendicularly from a first die wall of the plurality of die walls, the first member including a body portion having a first width and a stem portion having a second width less than the first width such that the die component is configured to form a first linear sidewall between the body portion and the second die wall, a second linear sidewall between the body portion and the third die wall, a first lip portion between the stem portion and the second die wall, and a second lip portion between the stem portion and the third die wall;
a removal component configured to locate an access section of the raw track and, from the access section, remove one of the first linear sidewall or the second linear sidewall; and
a bend component configured to bend the access section.

11. The system of claim 10, wherein the die component includes a second member extending substantially perpendicularly from one of the second die wall or the third die wall, the second member spaced from a fourth die wall of the plurality of die walls and the first member such that the die component is configured to form a first projection between the second member and the fourth die wall and a second projection between the second member and the first member.

12. The system of claim 10, wherein the bend component is configured to bend the access section such that a first longitudinal segment of the access section is generally aligned with a retention section of the raw track and a second longitudinal segment of the access section is substantially perpendicular to the retention section.

13. The system of claim 10, wherein the bend component is configured to bend the access section such that at least a longitudinal segment of the access section has a generally arcuate configuration.

14. A method of fabricating a track configured to couple an enclosure to a roof of a golf cart, the method comprising:
forming a raw track including a first linear sidewall, a second linear sidewall spaced from the first linear sidewall to define an enclosure channel therebetween, a first lip portion extending from a first end portion of the first linear sidewall generally toward the second linear sidewall, and a second lip portion extending from a second end portion of the second linear sidewall generally toward the first linear sidewall, the second lip portion spaced from the first lip portion to define a slot therebetween, the slot sized to retain an enclosure cord extending through the enclosure channel in the enclosure channel;
locating one or more access sections of the raw track;
removing, from the one or more access sections, one of the first linear sidewall or the second linear sidewall; and
bending the one or more access sections to provide a custom track.

15. The method of claim 14 further comprising coupling the custom track to the roof of the golf cart.

16. The method of claim 14, wherein forming the raw track includes forming the raw track to include a first projection and a second projection spaced from the first projection such that the first projection and the second projection define a roof channel therebetween, the roof channel sized to receive an edge portion of the roof of the golf cart.

17. The method of claim 14, wherein forming the raw track includes forming the raw track to include a first projection and a second projection spaced from the first projection such that the first projection and the second projection define a roof channel therebetween, one of the first projection or the second projection extending between the first linear sidewall and the second linear sidewall to partially define the enclosure channel.

18. The method of claim 14, wherein forming the raw track includes forming the raw track to include a first projection and a second projection spaced from the first projection such that the first projection and the second projection define a roof channel therebetween, the first projection and the second projection substantially perpendicular to the first linear sidewall and the second linear sidewall.

19. The method of claim 14, wherein bending the one or more access sections includes bending a first access section of the one or more access sections such that a first longitudinal segment of the first access section is substantially perpendicular to a second longitudinal segment of the first access section.

20. The method of claim 14, wherein bending the one or more access sections includes bending a first access section of the one or more access sections such that at least a longitudinal segment of the first access section has a generally arcuate configuration.
